(19) United States
(12) Patent Application Publication
(10) Pub. No.: US 2008/0021947 A1
(43) Pub. Date: Jan. 24, 2008

(54) Triple-base number digital signal and numerical processing system

(76) Inventors: Amitabha Sinha, Kolkata (IN); Pavel Sinha, Montreal (CA); Kenneth Alan Newton, Kutztown, PA (US); Krishanu Mukherjee, Kolkata (IN)

Correspondence Address: MANELLI DENISON & SELTER PLLC, 7th Floor, 2000 M Street, N.W., Washington, DC, 20036-3307, US

(21) Appl. No.: 11/488,138

(22) Filed: Jul. 18, 2006

(51) Int. Cl. G06F 7/52

(52) U.S. Cl. 708/620

(57) ABSTRACT

A processor includes a triple-base-number-system (TBNS) Arithmetic Unit architecture. TBNS processing enables extremely high-performance digital signal processing of larger word-size data, and enables a processor architecture having reduced hardware complexity and power dissipation. With demanding signal processing applications a TBNS processing is much more efficient as compared to either traditional SBNS or even DBNS. In a processor, a Multiplication Unit comprises at least three Adders to each add an extracted pair of like powers of two numbers to be multiplied. A result of one Adder controls a number of bits of shift of a barrel shifter, and a result of remaining Adders are input to a lookup table feeding the barrel shifter. A register holds an output of the barrel shifter. TBNS processing system includes a binary-to-TBNS data converter adapting a Binary-Search-Tree and Range Table to convert binary data/numbers into TBNS representation.

### BACKGROUND OF THE INVENTION

1. Field of the Invention

This invention relates generally to processors, in particular digital signal processors (DSPs). More particularly, it relates to an improved number system and arithmetic architecture in a processor.

2. Background of Related Art

High performance digital signal processing presents many challenges in real-time applications because of their high computational complexity. Major design issues include how to improve the performance of processor arithmetic units in general, and how to improve the performance of multiplication and addition operations in particular.

Traditional single-base number systems (SBNS), such as binary, octal, decimal or hexadecimal are the basis for all mainstream digital processing systems to date. Double-base number systems (DBNS) were introduced as a method to process arithmetic operations more efficiently than can systems based on traditional SBNS. However, as is appreciated by the inventors hereof, while DBNS schemes exhibit good computation performance with 8-bit word-size data, their performance degrades significantly with 16-bit or larger word-size data due to the resulting greatly increased hardware complexity and increased calculation latency. Thus, wide spread adoption of DBNS processing systems has not taken place.

There is a need for processing Arithmetic Units and methods that improve upon the efficiency of both SBNS and DBNS Arithmetic Units and methods.

### SUMMARY OF THE INVENTION

In accordance with the principles of the present invention, a Multiplication Unit of a processor comprises at least three Adders. Each of the Adders adds a pair of like powers which were extracted for the two numbers being multiplied. A result of a first one of said at least three Adders controls a number of bits of shift of a barrel shifter. A result of remaining ones of the at least three Adders is input to a lookup table that feeds the barrel shifter.

In accordance with another aspect of the invention a single-cycle generation architecture for a high precision finite impulse response (FIR) filter in accordance with another aspect of the invention comprises a plurality of single cycle generators connected in series. A first one of the plurality of single cycle generators has as an input a signal sample. Each of the plurality of single cycle generators provides an output signal to a respective buffer stage of the FIR filter. Each of the plurality of single cycle generators comprises a triple-base number system (TBNS) Multiplication Unit.

A method of multiplying multiple numbers in a processor according to yet another aspect of the invention comprises extracting triple-base powers from each of the multiple numbers. Like triple-base powers for each of the multiple numbers are added into a single binary power result. Results of the highest two powers are input into a lookup table. An output of the lookup table is input to a barrel shifter. A result of a lowest power is input to control a number of bits of shift of the barrel shifter. An output of the barrel shifter represents a result of the multiplication operation.

### BRIEF DESCRIPTION OF THE DRAWINGS

Features and advantages of the present invention will become apparent to those skilled in the art from the following description with reference to the drawings, in which:

FIG. 1 depicts a DBNS table where i and j both range from 0 to 3.

FIG. 2 depicts the number of iterations (N) needed for converting all possible 8-bit binary numbers to a DBNS representation using the greedy algorithm.

FIG. 3 depicts a TBNS table where i and j both range from 0 to 2.

FIG. 4 shows exemplary hardware structure for the expression of single-bit multiplication of two binary numbers using DBNS multiplication.

FIG. 5 shows the total operation of DBNS multi-bit multiplication.

FIGS. 6(a) and 6(b) depict the hardware complexity in terms of the required MUs and Adders for DBNS multi-bit multiplication.

FIG. 7 shows an exemplary hardware implementation of TBNS single-bit multiplication.

FIG. 8 shows the total operation of TBNS multi-bit multiplication.

FIGS. 9(a) and 9(b) depict the hardware complexity in terms of the required TBNS MUs (TMUs) and Adders.

FIG. 10 is a table comparing the use of DBNS or TBNS architecture to multiply two numbers.

FIGS. 11(a) and 11(b) show a comparison between DBNS and TBNS for multi-bit multiplications in terms of the required number of Multiplication Units and Adders size.

FIG. 12 shows that when there is an increase in the numbers to be multiplied, DBNS suffers much greater hardware complexity in terms of LUT size than does TBNS.

FIG. 13 represents the number of LUT locations for Multiple-Base-Number-System (MBNS) single bit multiplication.

FIGS. 14(a) and 14(b) show that both the X(k) and H(n−k) can have a maximum of five cells to represent the number in an exemplary FIR filter.

FIG. 15 shows a single cycle X(k) generation scheme forming a high precision FIR filter, in accordance with the principles of the present invention.

FIG. 16 shows an exemplary smaller range table for 8-bit data/numbers.

FIG. 17 shows an exemplary range table for 16-bit binary data/numbers.

FIG. 18 shows exemplary architecture of an m-bit single conversion processing element (CPE) converter, in accordance with the principles of the present invention.

FIG. 19 shows exemplary architecture of an 8-bit pipelined conversion processing element (CPE) converter, in accordance with the principles of the present invention.

FIG. 20 shows exemplary architecture of a 16-bit pipelined conversion processing element (CPE) converter, in accordance with the principles of the present invention.

FIG. 21 shows exemplary architecture of a conversion processing element (CPE) scaled for an 8-bit converter, in accordance with the principles of the present invention.

FIG. 22 shows an exemplary priority encoder input/output table for an 8 bit converter, in accordance with the principles of the present invention.

FIG. 23 shows exemplary architecture of a conversion processing element (CPE) scaled for a 16-bit converter, in accordance with the principles of the present invention.

FIG. 24 shows an exemplary priority encoder input/output table for a 16-bit converter, in accordance with the principles of the present invention.

### DETAILED DESCRIPTION OF ILLUSTRATIVE EMBODIMENTS

The present invention introduces triple-base number system (TBNS) Arithmetic Unit architecture within a processor. To better understand and appreciate the novelty and importance of TBNS processing, double-base number system (DBNS) processing will be compared and contrasted.

A comparison between TBNS and DBNS arithmetic architecture clearly demonstrates the advantages of a TBNS arithmetic architecture, in terms of greater speed, reduced hardware complexity and reduced processor power dissipation. Novel architectural models are proposed, and a design methodology with small design steps has been successfully used.

Advances in digital signal processing require very high speed processing on signal data in real-time with a high degree of adaptability. Moreover, among the most important goals in digital signal processor (DSP) architecture is the minimization of energy consumption and heat dissipation. Current advanced signal processing architecture creates difficult challenges in real-time applications because of the need for high computational complexity. Since most DSP arithmetic unit architecture designs are based on multiplication and addition operations, major design objectives have been the speed enhancement of processor Arithmetic Units in general, and of multiplication and addition operations in particular.

A number of well known schemes, such as a look-ahead carry Adder, a carry-save Adder, and pipelined floating-point Adders have been proposed to improve the performance of Adder and Subtractor Units. Similarly, efficient Multiplication Units that have been used include Dadda's Multipliers, pipelined array Multipliers, distributed arithmetic, logarithmic Multipliers, and pipelined floating-point Multipliers.

Double-base number systems (DBNS) are capable of performing multiplication operations. To use a DBNS, data/numbers from one a single-base number systems (SBNS), such as binary, octal, decimal and hexadecimal, is converted to its DBNS equivalent. Addition and multiplication operations can be performed more quickly in their DBNS equivalent representations by using the key index ([i,j] pairs which were extracted at the time of conversion between the two number systems.

In accordance with the preferred embodiments of the present invention, computational performance is further improved by the introduction of an innovative number system coding concept more efficient than either the SBNS or the DBNS, referred to herein as Triple-base number systems (TBNS).

A double-base number system is a special way of representing integers as a sum of mixed powers of two (2) and three (3), which are known as two integers. This number representation scheme is unusually compact which is a good measure for potential processing applications.

In DBNS, integers are represented in the following form:

$$x = {\sum }_{i , j} {d}_{i , j} {2}^{i} {3}^{j} . \\ where {d}_{i , j} = \{ 0 , 1 \}$$

### The binary number system is a special case of the above representation.

From this expression it is clear that a given binary number when converted into a DBNS representation can be represented as a number of (i,j) pairs, also referred to as DBNS indices.

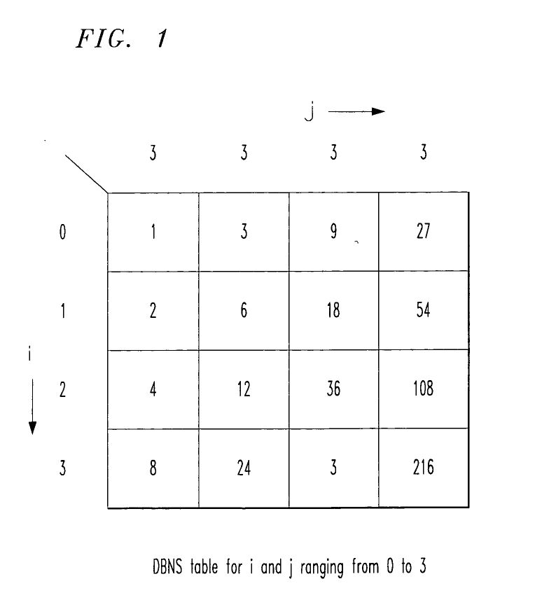

FIG. 1 depicts a DBNS table where i and j both range from 0 to 3.

An iterative approach for computing the DBNS indices is known as a ‘GREEDY’ algorithm. Because at least one iteration of this algorithm is required to find one of the indices, the total number of iterations indicates the number of ones (1s) in the DBNS table, which are often referred to as cells. The values given in each box in the DBNS table indicate the weight for the corresponding cell. The maximum decimal number which can be represented by a DBNS system comprised of (m*n) cells can be obtained by adding the weighs of all the (m*n) cells. From FIG. 1 it can be seen that a 4*4 DBNS table can represent a maximum decimal number of 600.

A greedy algorithm which provides a so-called “near-canonic” double-base number representation (NCDBNR) is as follows:

```
GREEDY (x)
{
  if (x > 0) then
do{
    find the largest 2-integer w such that w ≦ x;
    write(w);
    x = x−w;
    GREEDY(x);
  }
}
```

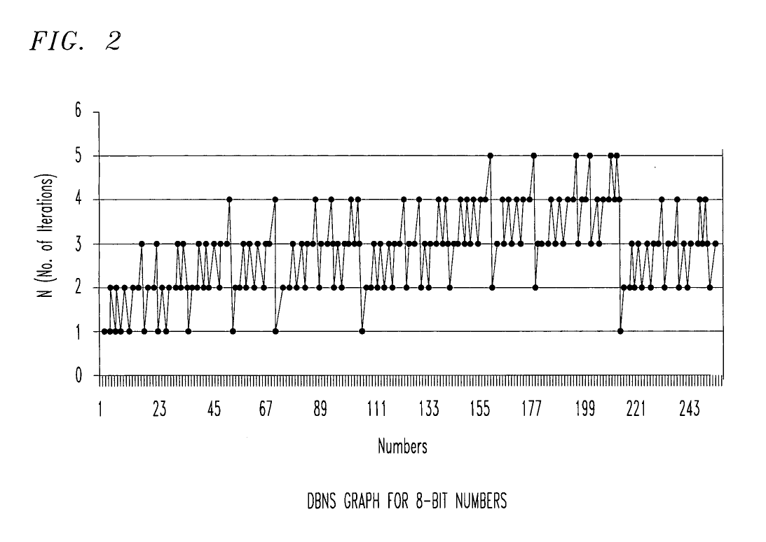

FIG. 2 depicts the number of iterations (N) needed for converting all possible 8-bit binary numbers to a DBNS representation using the greedy algorithm.

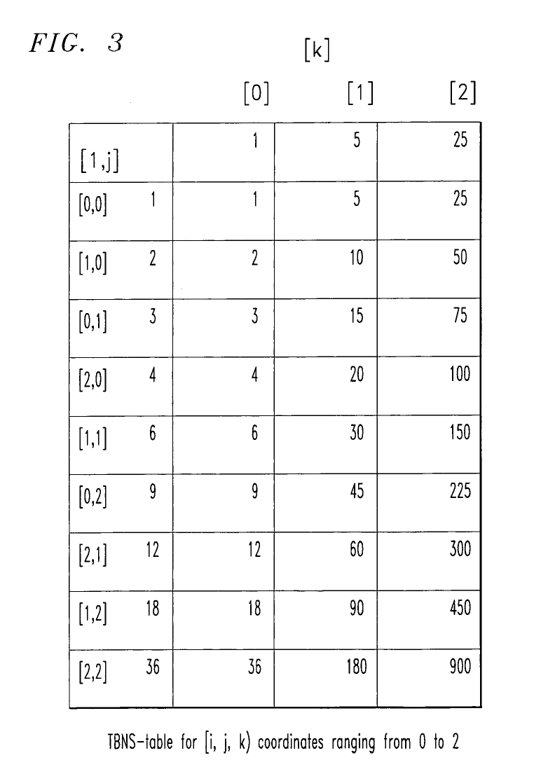

In particular, from FIG. 3 it can be seen that:
1. The Maximum number of iterations N is 5, and the minimum number of iterations N is 0; and
2. For those instances where the number of iterations N is high (e.g., 5), a triple-base number system (TBNS) is much more advantageous than a DBNS.

In TBNS, integers are expressed in powers of the three lowest prime numbers: two (2), three (3) and five (5).

FIG. 3 depicts a TBNS table where i and j both range from 0 to 2. In TBNS, integers are represented in the following form:

$$X = {\sum }_{i , j , k} {d}_{i , j , k} {2}^{i} {3}^{j} {5}^{k}$$

$$where \text{:} {d}_{i , j , k} = \{ 0 , 1 \}$$

### The following example shows how representation in TBNS is superior to that in DBNS:

Example—For 179, N=5 in DBNS.
   For 179, N=3 in TBNS.

Interestingly, most of the integers for which the number of iterations is high are prime integers. E.g., 53, 71, 107, 143, 161 and 179 are prime numbers. This explains the use of prime numbers as the base powers in the multi-base number systems in accordance with the principles of the present invention. Thus, a four-base number system would use powers of 2, 3, 5 and 7; while a five-base number system would use powers of 2, 3, 5, 7 and 11.

As another example, integer=71:
In DBNS (2, 3), for 71, N=4
In TBNS (2, 3, 5), for 71, N=3
In 4BNS (2, 3, 5, 7), for 71, N=2

The most common functions in a numerical processor are addition and multiplication, this is particularly so in a DSP. Thus, after converting a given binary number to its DBNS representation, DBNS additions and multiplications would typically be performed. To accomplish this the [i,j] index pairs that were determined at the time of binary-to-DBNS conversion are utilized as the operators for addition and multiplication operations in DBNS processing.

A binary number converted to DBNS is represented by a unique set of [i,j] index pairs, however, such index pairs are represented in plain binary form. Because the extracted [i,j] pairs exist as plain binary, DBNS addition operations provide no performance advantage over plain binary addition. Accordingly, addition in DBNS is preferably totally performed in plain binary form.

However, with respect to DBNS multiplication, it can be accomplished by simply summing the [i, j] pairs in powers of 2 and 3. Thus, the complexity of multiplication is greatly reduced using a multiple-base number system. This gives a great performance advantage to DBNS multiplication over traditional SBNS multiplication.

The expression of single-bit multiplication of two binary numbers X and Y is given by

X*Y=(2ⁱ.3^{j})×(2^{m}.3ⁿ)=2^{i+m}.3^{j+n}

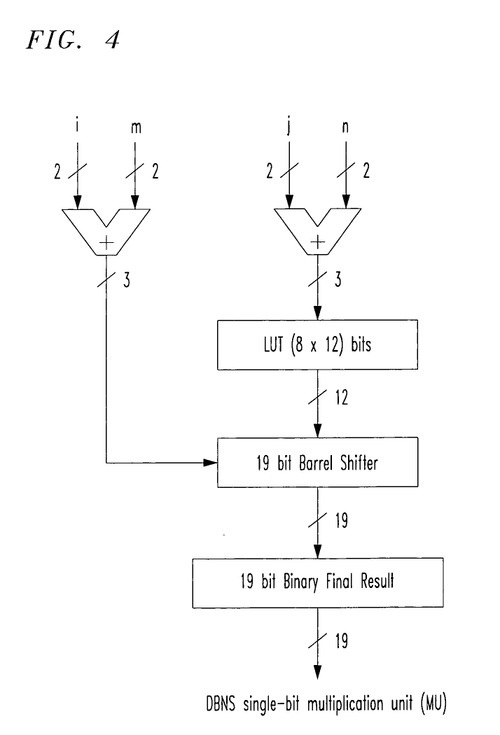

FIG. 4 shows exemplary hardware structure for the expression of single-bit multiplication of two binary numbers using DBNS multiplication.

In particular, as shown in FIG. 4, the indices (i, m) and (j, n) of the respective bases are first added using binary Adders. The result of the 2nd addition, i.e. (j+n), is stored in a lookup table (LUT) and then shifted by (i+m) bits in a single clock using a barrel shifter. The final result is preferably stored in a register. The single-bit multiplication block is called a Multiplication Unit (MU).

With respect to time complexity of DBNS single-digit multiplication, let us set the time required for addition=t_{Add}, the time delay of the lookup table (LUT)=t_{LUT}, and the time required for Barrel Shifting=t_{Shift}. Accordingly, the total delay (tₘᵤₗₜ) of the Multiplier cell is given by

tₘᵤₗₜ=t_{Add}+t_{LUT}+t_{Shift}

With respect to the complexity of a hardware implementation of DBNS single-digit multiplication, the length of the Adder depends on the length of i, j, m and n. If i, j, m and n are all ‘s’ bits long, then both the Adders will be ‘s’ bit Adders, and the output of them would be a maximum of ‘s+1’ bits.

A lookup table (LUT) is required to compute the value of 0+n) in a power of 3. Again, the complexity of the lookup table (LUT) depends on the length of j and n. The output of the LUT is shifted by a barrel shifter to get the result, where (i+m) indicates the number of shifts.

Let us take a 4*4 DBNS table. In this case, i, j, m and n are each 2 bits, and would be added using 2 bit Adders, with a result having a maximum of 3 bits.

As a result, the number of lookup table (LUT) locations=23=8.

Since the LUT computes the value of (j+n) in a power of 3, the value of (j+n) can be a maximum of (3+3)=6. To represent 3⁶, i.e., 729, in binary form, 10 bits are required. So, the minimum length of each location is 10. But since the input is 3 bits wide, the LUT must be capable of calculating up to 37, i.e., 2187, for which 12 bits are required. Thus, the length of each location is 12 bits.

As a result, the size of the lookup table (LUT) is =(8*12) bits.

In the barrel shifter, there is a shift of 7 bits due to the output of the first Adder. This is because the output of (i+m) can be a maximum of 3 bits.

Hence, the final output of DBNS single bit multiplication in the given example has (12+7)=19 bits.

In the case of DBNS multi-bit multiplication, an example using a 4*4 DBNS Table is analyzed. In this case, when an 8-bit number is converted into its DBNS representation, it can generate a maximum of 5 [i, j] pairs. Thus, when numbers X and Y are to be multiplied, first the numbers are converted into DBNS representations using relevant conversion logic, where corresponding [i, j] pairs are extracted, and the product is computed using a suitable DBNS multiplication method.

Let A and B be two numbers represented in DBNS form in the following expressions:

$$A = ( {2}^{i 1} \cdot {3}^{j 1} + {2}^{i 2} \cdot {3}^{j 2} + {2}^{i 3} \cdot {3}^{j 3} + {2}^{i 4} \cdot {3}^{j 4} + {2}^{i 5} \cdot {3}^{j 5} )$$

$$B = ( {2}^{m 1} \cdot {3}^{n 1} + {2}^{m 2} \cdot {3}^{n 2} + {2}^{m 3} \cdot {3}^{n 3} + {2}^{m 4} \cdot {3}^{n 4} + {2}^{m 5} \cdot {3}^{n 5} )$$

$$So , A * B = ( {2}^{i 1} \cdot {3}^{j 1} + {2}^{i 2} \cdot {3}^{j 2} + {2}^{i 3} \cdot {3}^{j 3} + {2}^{i 4} \cdot {3}^{j 4} + {2}^{i 5} \cdot {3}^{j 5} ) * ( {2}^{m 1} \cdot {3}^{n 1} + {2}^{m 2} \cdot {3}^{n 2} + {2}^{m 3} \cdot {3}^{n 3} + {2}^{m 4} \cdot {3}^{n 4} + {2}^{m 5} \cdot {3}^{n 5} ) = ( {2}^{i 1 + m 1} {3}^{j 1 + n 1} + {2}^{i 1 + m 2} {3}^{j 1 + n 2} + {2}^{i 1 + m 3} {3}^{j 1 + n 3} + {2}^{i 1 + m 4} {3}^{j 1 + n 4} + {2}^{i 1 + m 5} {3}^{j 1 + n 5} ) + ( {2}^{i 2 + m 1} {3}^{j 2 + n 1} + {2}^{i 2 + m 2} {3}^{j 2 + n 2} + {2}^{i 2 + m 3} {3}^{j 2 + n 3} + {2}^{i 2 + m 4} {3}^{j 2 + n 4} + {2}^{i 2 + m 5} {3}^{j 2 + n 5} ) + ( {2}^{i 3 + m 1} {3}^{j 3 + n 1} + {2}^{i 3 + m 2} {3}^{j 3 + n 2} + {2}^{i 3 + m 3} {3}^{j 3 + n 3} + {2}^{i 3 + m 4} {3}^{j 3 + n 4} + {2}^{i 3 + m 5} {3}^{j 3 + n 5} ) + ( {2}^{i 4 + m 1} {3}^{j 4 + n 1} + {2}^{i 4 + m 2} {3}^{j 4 + n 2} + {2}^{i 4 + m 3} {3}^{j 4 + n 3} + {2}^{i 4 + m 4} {3}^{j 4 + n 4} + {2}^{i 4 + m 5} {3}^{j 4 + n 5} ) + ( {2}^{i 5 + m 1} {3}^{j 5 + n 1} + {2}^{i 5 + m 2} {3}^{j 5 + n 2} + {2}^{i 5 + m 3} {3}^{j 5 + n 3} + {2}^{i 5 + m 4} {3}^{j 5 + n 4} + {2}^{i 5 + m 5} {3}^{j 5 + n 5} )$$

From the above expression, we determine that the expressions in each bracket actually contain 5 single-bit multiplications. So, to implement a multi-bit DBNS Multiplier (5×5), 25 Multiplication Units (MUs) are required. The results from each Multiplication Unit are added.

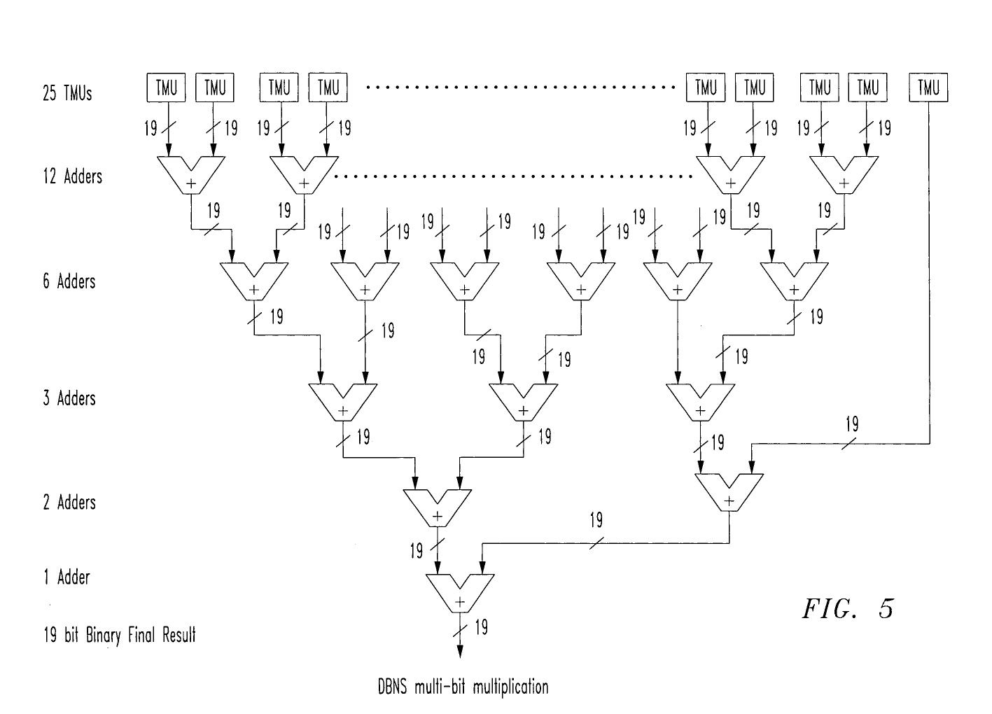

FIG. 5 shows the total operation of DBNS multi-bit multiplication.

In particular, as shown in FIG. 5 with respect to the time complexity of the DBNS multi-bit multiplication, all Multipliers are a single cell Multiplier each having four (4) inputs. The 25 outputs from the Multipliers are then added using carry look-ahead Adders.

Five (5) stages are required to generate the final result. Given that the delay of a Multiplier is tₘᵤₗₜ, and the delay of one carry look ahead Adder is t_{CLA}, the total time to compute one complete multi-bit multiplication=tₘᵤₗₜ+5t_{CLA}.

With respect to the hardware complexity of DBNS multi-bit multiplication, to implement multi-bit multiplication of two numbers the following are evident:
MUs Required=25
Adders required=(12+6+3+2+1)=24.

Since the single-bit multiplication output has 19 bits, all the carry look-ahead Adders must be 19 bit Adders.

To multiply more than two numbers in DBNS form, i.e. to compute (A*B*C):

### MUs required=(5*5*5)=125

### Adders required=(62+31+16+8+4+2+1)=124 (7 stages).

### Total Time required=tₘᵤₗₜ+7 t_{CLA}

### To compute (A*B*C*D),

### MUs required=(5*5*5*5)=625

### Adders required=(312+156+78+39+20+10+5+2+2+1)=624 (10 stages).

### Total Time required=tₘᵤₗₜ+10 t_{CLA}

With the foregoing as background, we can generalize the hardware complexity necessary to multiply N numbers in DBNS as requiring 5^{N} Multiplication Units (MUs) and (5^{N}−1) Adders.

However, the required number of Multiplication Units is not the same in all cases. Rather, the size of the lookup table, and the output bits, are different in different cases.

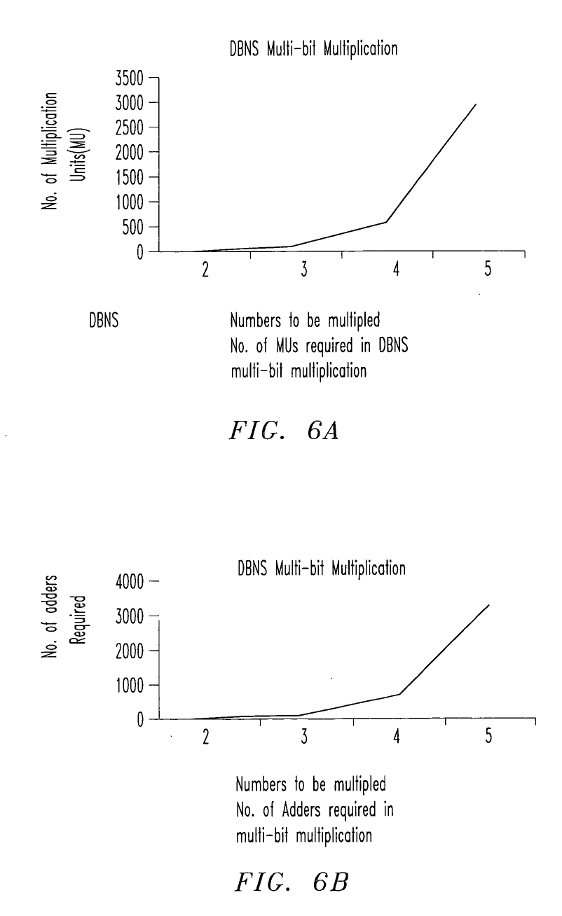

FIGS. 6(a) and 6(b) depict the hardware complexity in terms of the required MUs and Adders for DBNS multi-bit multiplication.

The reduced complexity of a triple-base number system (TBNS) is now discussed. To begin this discussion, a general expression for TBNS single-bit multiplication is shown below:

(2ⁱ.3^{j.}5^{k})×(2^{m}.3^{n.}5^{p})=2^{i+m}.3^{j+n}.5^{k+p}

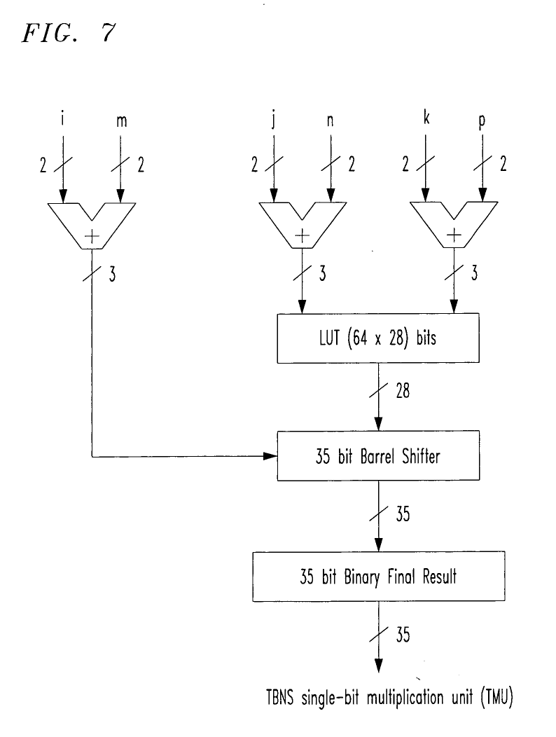

FIG. 7 shows an exemplary hardware implementation of TBNS single-bit multiplication.

In particular, as shown in FIG. 7, pairs (i+m), (j+n); and (k+p) are each added using respective binary Adders. The result of the 2^{nd} and 3^{rd} addition operations, i.e., (j+n) and (k+p) are stored in a lookup table (LUT), and then shifted by the amount (i+m) using a barrel shifter. The final result is stored in a register.

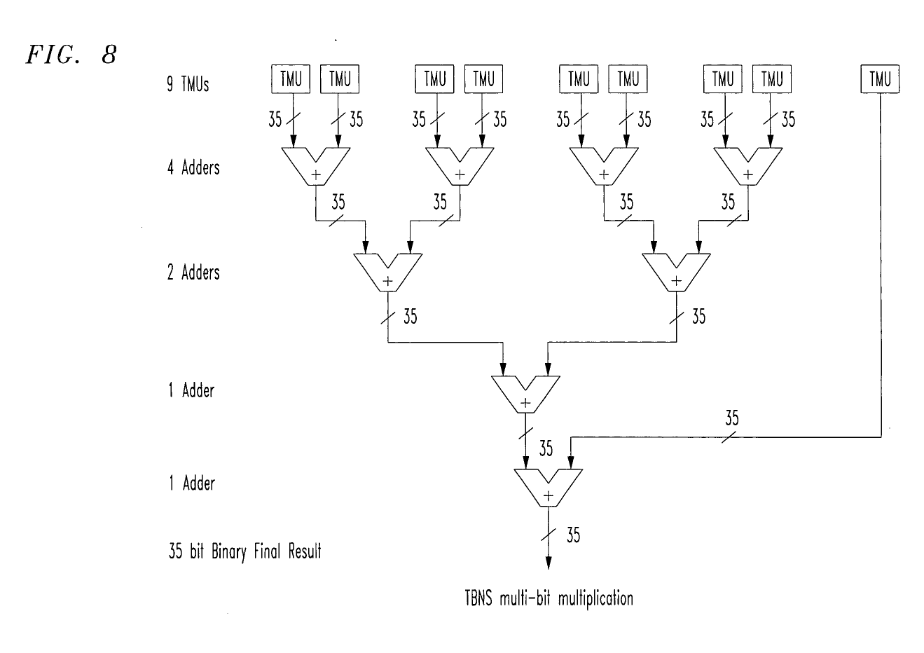

The entire TBNS single-bit multiplication block shown in FIG. 8 is referred to herein as a TBNS Multiplication Unit (MU).

Turning now to an analysis of the time complexity of TBNS single-bit multiplication, let the time taken for addition=t_{Add}, the time delay of the lookup table (LUT)=t_{LUT}, and the time required for the barrel shifter=t_{Shift}. Thus, the total delay of the Multiplier cell is tₘᵤₗₜ=t_{Add}+t_{LUT}+t_{Shift}. The expression of time complexity remains the same as represented with respect to a DBNS Multiplication Unit (MU). Thus:

tₘᵤₗₜ(TMU)=tₘᵤₗₜ(MU)

With respect to an analysis of the hardware complexity of TBNS single-bit multiplication, the length of the Adder depends on the length of i, j, m, n, k & p. If i, j, m and n are all ‘s’ bits long, then the Adders will be an ‘s’ bit Adder, and the output of them will be a maximum of ‘s+1’ bits. The lookup table (LUT) is required to compute the value of (j+n) in a power of 3 and (k+p) in a power of 5. Again, the complexity of the LUT depends on the length of j, n, k and p. The output of the LUT is shifted by the barrel shifter to get the result, where (i+m) indicates the number of shifts.

If we take a 4*4*4 TBNS table, then i, j, m, n, k and p are 2 bits long. Then they are added using 2 bit Adders, and the result has a maximum of 3 bits.

Accordingly, the number of lookup table (LUT) locations=2³⁺³=64.

At first, the LUT computes the value of (j+n) in a power of 3, and (k+p) in a power of 5. Then, the LUT computes the multiplications required by the expression (3^{j+n}.5^{k+p}).

The value of both (j+n) and (k+p) can be maximum of (3+3)=6 bits. To represent 5⁵, i.e., 15625 in binary form, 14 bits are required. But since the input has 3 bits, the LUT must be capable of calculating up to 5⁷, i.e., 78125, for which 17 bits are required. Now to compute (5⁷×3⁷), i.e., 170,859,375, the number of bits required=28.

So, the required LUT size is =(64*28) bits.

In the barrel shifter, there is a shift of 7 bits due to the output of the first Adder because the output of (i+m) can be maximum 3 bits.

Hence, the final output of TBNS single bit multiplication has (28+7)=35 bits.

We turn now to an analysis of TBNS multi-bit multiplication, using as an example a 4*4*4 TBNS table. When an 8-bit number is converted into DBNS, it can generate a maximum of 3 [i, j, k]. So, when numbers X and Y are to be multiplied, first the numbers X, Y are converted into TBNS representations using appropriate conversion logic in the processor. Then the corresponding [i, j, k] are extracted, and the result of the multiplication is computed using the TBNS multiplication method in accordance with the principles of the present invention.

To aid in the analysis, let us set A and B as TBNS representations in the following expressions:

$$A = ( {2}^{i 1} \cdot {3}^{j 1} \cdot {5}^{k 1} + {2}^{i 2} \cdot {3}^{j 2} \cdot {5}^{k 2} + {2}^{i 3} \cdot {3}^{j 3} \cdot {5}^{k 3} )$$

$$B = ( {2}^{i 1} \cdot {3}^{j 1} \cdot {5}^{p 1} + {2}^{i 2} \cdot {3}^{j 2} \cdot {5}^{p 2} + {2}^{i 3} \cdot {3}^{j 3} \cdot {5}^{p 3} )$$

$$\begin{matrix}A * B = ( {2}^{i 1} \cdot {3}^{j 1} \cdot {5}^{k 1} + {2}^{i 2} \cdot {3}^{j 2} \cdot {5}^{k 2} + {2}^{i 3} \cdot {3}^{j 3} \cdot {5}^{k 3} ) \cdot \\ ( {2}^{i 1} \cdot {3}^{j 1} \cdot {5}^{p 1} + {2}^{i 2} \cdot {3}^{j 2} \cdot {5}^{p 2} + {2}^{i 3} \cdot {3}^{j 3} \cdot {5}^{p 3} ) \\ = ( {2}^{i 1 + m 1} {3}^{j 1 + n 1} {5}^{k 1 + p 1} + {2}^{i 1 + m 2} {3}^{j 1 + n 2} {5}^{k 1 + p 2} + {2}^{i 1 + m 3} {3}^{j 1 + n 3} {5}^{k 1 + p 3} ) + \\ ( {2}^{i 2 + m 1} {3}^{j 2 + n 1} {5}^{k 2 + p 1} + {2}^{i 2 + m 2} {3}^{j 2 + n 2} {5}^{k 2 + p 2} + {2}^{i 2 + m 3} {3}^{j 2 + n 3} {5}^{k 2 + p 3} ) + \\ ( {2}^{i 3 + m 1} {3}^{j 3 + n 1} {5}^{k 3 + p 1} + {2}^{i 3 + m 2} {3}^{j 3 + n 2} {5}^{k 3 + p 2} + {2}^{i 3 + m 3} {3}^{j 3 + n 3} {5}^{k 3 + p 3} )\end{matrix}$$

From the above expression, we determine that the expressions of each bracket actually contain 3 single-bit multiplications. So, to implement a multi-bit DBNS Multiplier (3×3)=9 TBNS MUs (TMUs) are required. The results from each Multiplier are then added.

FIG. 8 shows the total operation of TBNS multi-bit multiplication.

With respect to the time complexity of TBNS multi-bit multiplication, all TBNS Multipliers are single cell Multipliers having 6 inputs. The 9 outputs from the Multipliers then added using ‘carry look ahead’ Adders.

The number of stages required to generate the final result=4. Presuming the delay of a Multiplier is tₘᵤₗₜ, and that the delay of one carry look ahead Adder is t_{CLA}, the total time required to compute one complete multi-bit multiplication=tₘᵤₗₜ+4 t_{CLA}.

With respect to the hardware complexity of TBNS multi-bit multiplication, to implement multi-bit multiplication of two numbers:
MUs Required=9
Adders required=(4+2+1+1)=8.

Since the single-bit multiplication output has 35 bits, all ‘carry look ahead Adders’ must be 35 bit Adders.

If multiplying more than two numbers in TBNS form, e.g., to compute (A*B*C):

### MUs required=(3*3*3)=27

### Adders required=(13+7+3+2+1)=26 (5 stages).

### Total Time required=tₘᵤₗₜ+5 t_{CLA}

### To compute (A*B*C*D),

### MUs required=(3*3*3*3)=81

### Adders required=(40+20+10+5+3+1+1)=80 (7 stages).

### Total Time required=tₘᵤₗₜ+7 t_{CLA}

Thus, the hardware complexity necessary to multiply N numbers in TBNS can be generalized as requiring 3N TBNS Multiplication Units (TMU) and (3^{N}−1) Adders.

The required number of TBNS Multiplication Units is not the same in all cases. Rather, the size of the lookup table, and the output bits, are different in different cases.

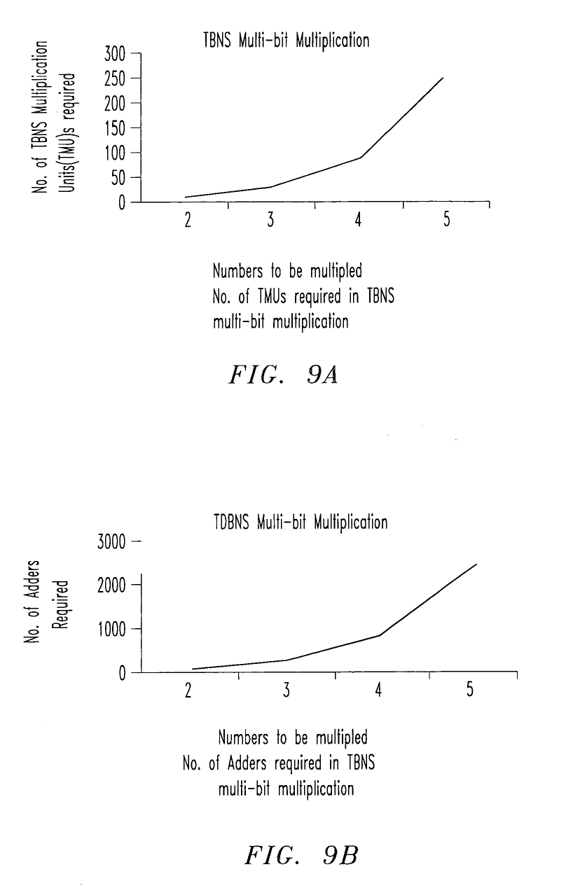

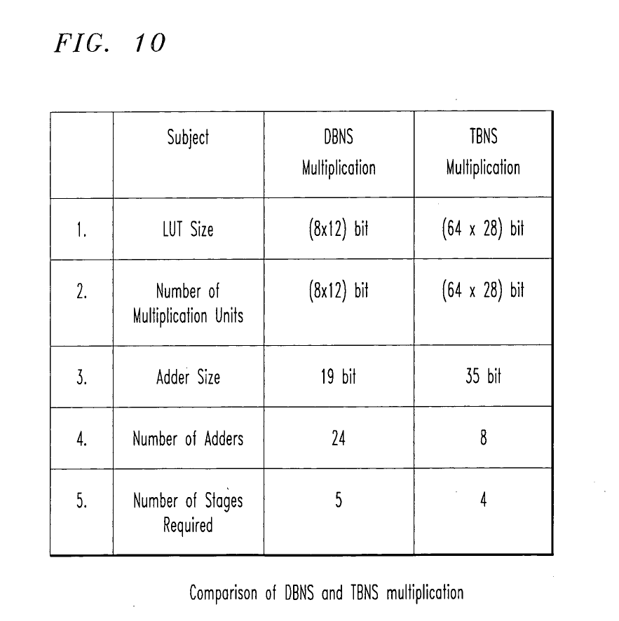

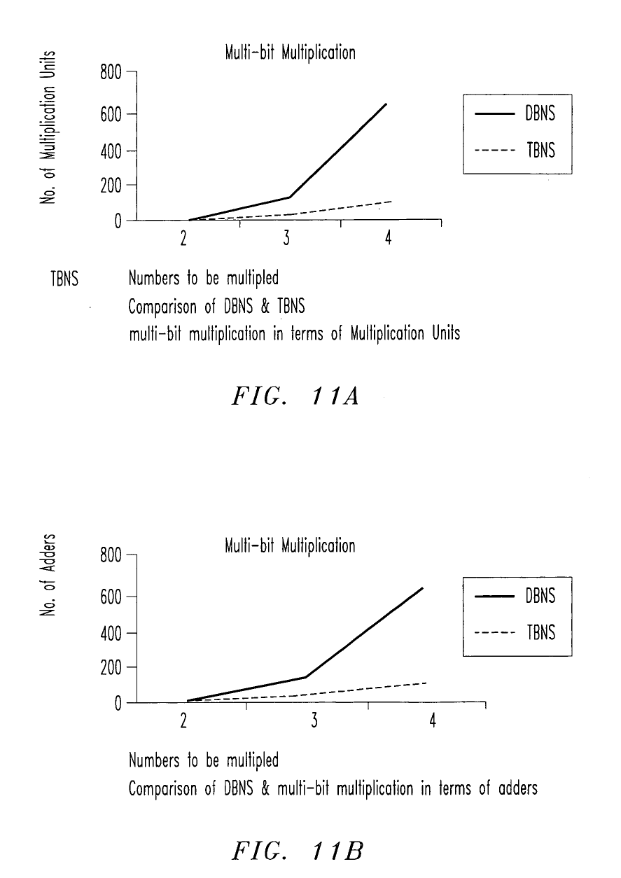

FIGS. 9(a) and 9(b) depict the hardware complexity in terms of the required TBNS MUs (TMUs) and Adders.

An embodiment of a high precision finite impulse response (FIR) filter using the triple-base number systems (TBNS) processor architecture is presented.

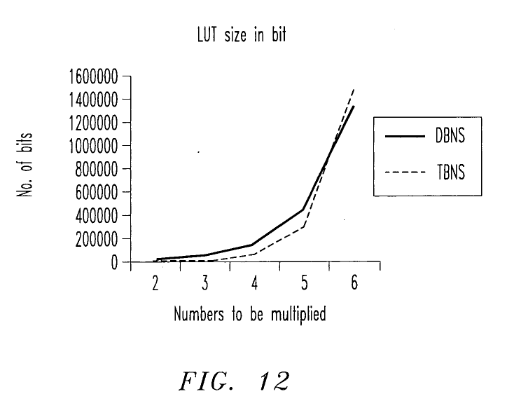

FIG. 10 is a table comparing the use of DBNS or TBNS architecture to multiply two numbers.

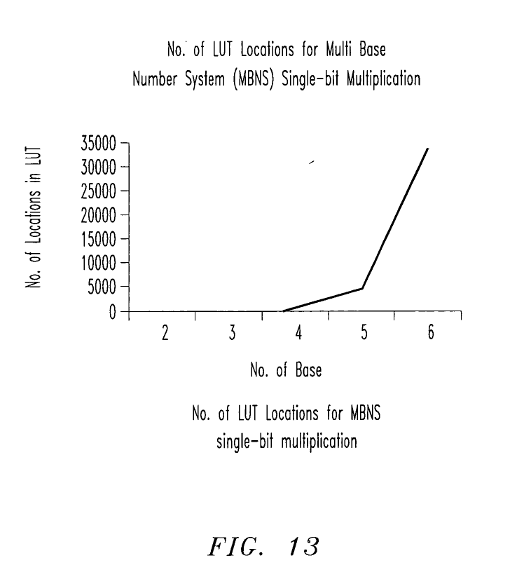

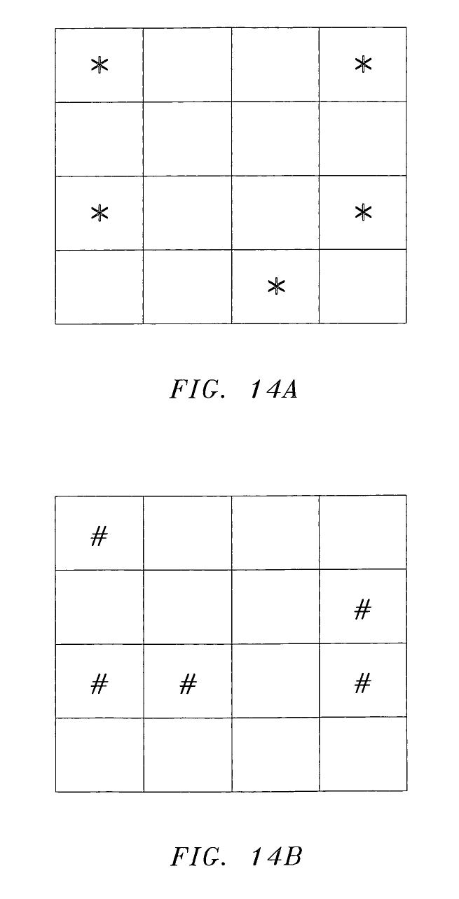

FIGS. 11(a) and 11(b) show a comparison between DBNS and TBNS for multi-bit multiplications in terms of the required number of Multiplication Units, Adders, and lookup table (LUT) size.

From the above discussion we conclude the following:
1. For N number of multiplications, Execution Time using DBNS (T_{dbns}) is given by,

T_{dbns}=tₘᵤₗₜ+[Integer part(N*2.32)+1]t_{CLA}
The same using TBNS (T_{tbns}) is given by

T_{tbns}=tₘᵤₗₜ+[Integer part(N*1.58)+1]t_{CLA}
Where tₘᵤₗₜ=time delay for Multiplier cell and t_{CLA}=same for Adder.
2. Calculation of Hardware Complexity to perform N number of multiplications.
i) Total bits required for each MU in DBNS=38+96+8=142-bits
   Total bits required for each Adder in DBNS=19-bits
   Therefore, the total bits required for multiplication of N numbers in DBNS=142*5^{N}+19(5^{N}−1)
ii) Similarly, the total bits required for multiplication of N numbers in TBNS=1874*3^{N}+35(3^{N}−1)
   The break-even point occurs when those totals are equal, i.e. 142*5^{N}+19(5^{N}−1)=1874*3^{N}+35(3^{N}−1)
   or, 3^{N} (1874+35)−35=(142+19) 5^{N}−19
   or, 3^{N}*1909=161*5^{N+16}
   or, 3^{N}*1909≈5^{N}*161 (neglecting the constant term, as it is relatively small)
   or, (⅗)^{N}=( 161/1909)=0.0843
   or, N log 0.6=log 0.0843
   or, N=4.84

The hardware complexity of the TBNS Arithmetic Unit is less than that of the DBNS Arithmetic Unit when the N number of multiplications is five (5) or more.
3. In general, it can be concluded that for N number of multiplications:
   TBNS based arithmetic exhibit much better performance compared to its DBNS counter part.
   The performance gain (η) is given by, η=((A−B)/(tₘᵤₗₜ+B+1), where A=Integer part of (N*2.32) & B=Integer part of (N*1.58).

For multiplication of five or more numbers TBNS yields better performance compared to DBNS.

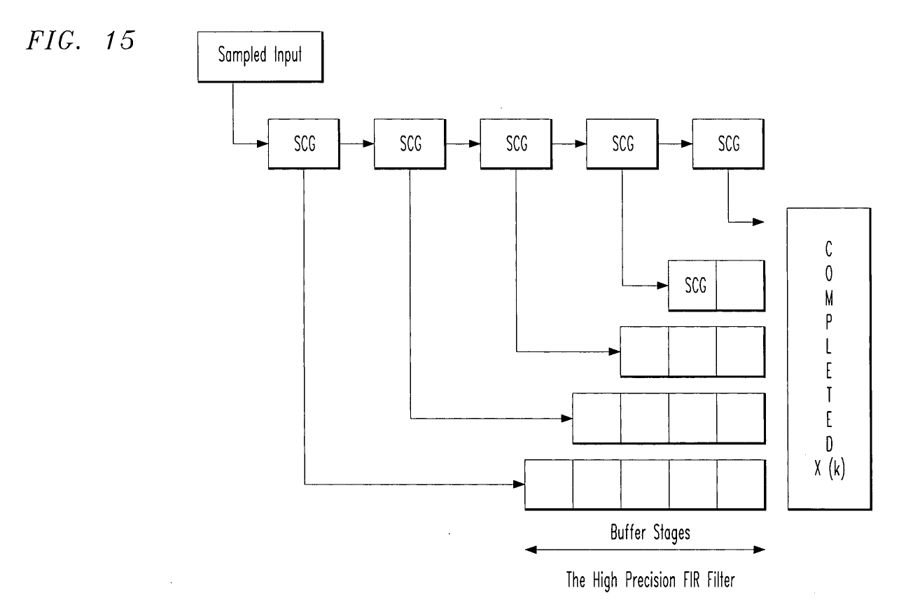

FIG. 12 shows that when there is an increase in the numbers to be multiplied, DBNS suffers much greater hardware complexity in terms of LUT size than does TBNS.

An important conclusion can be drawn from FIG. 12, in particular, that the use of TBNS architecture in accordance with the principles of the present invention is clearly preferable to compute larger word-size data as compared to DBNS because a TBNS processor offers less hardware and time complexity than does a DBNS processor.

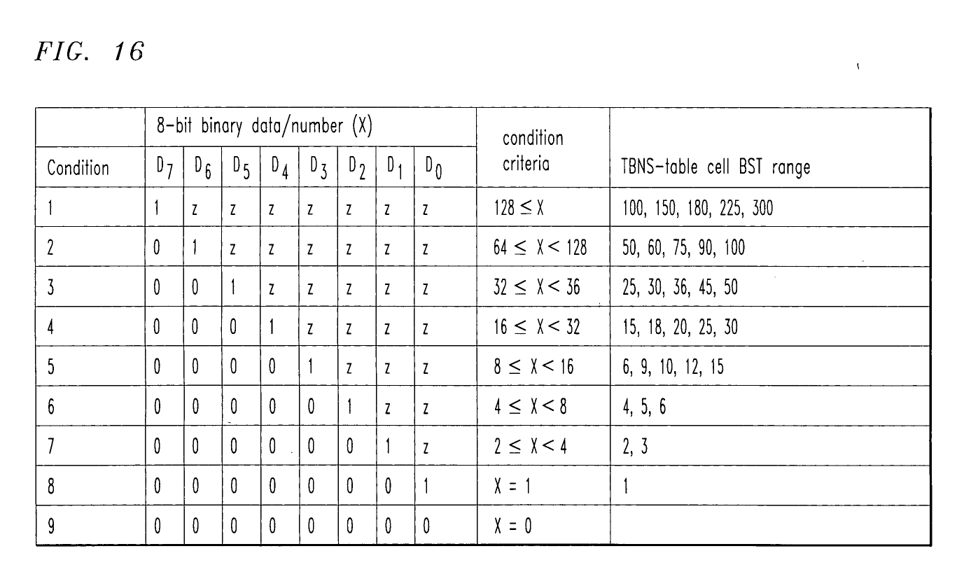

FIG. 13 represents the number of LUT locations for multiple-base number system (MBNS) single bit multiplication.

A high precision finite impulse response (FIR) filter can be represented by the following equation;

$$y ( n ) = {\sum }_{K = 0}^{N - 1} x ( n - k ) h ( k )$$

Where each x(n) will be multiplied by a proper h(k).

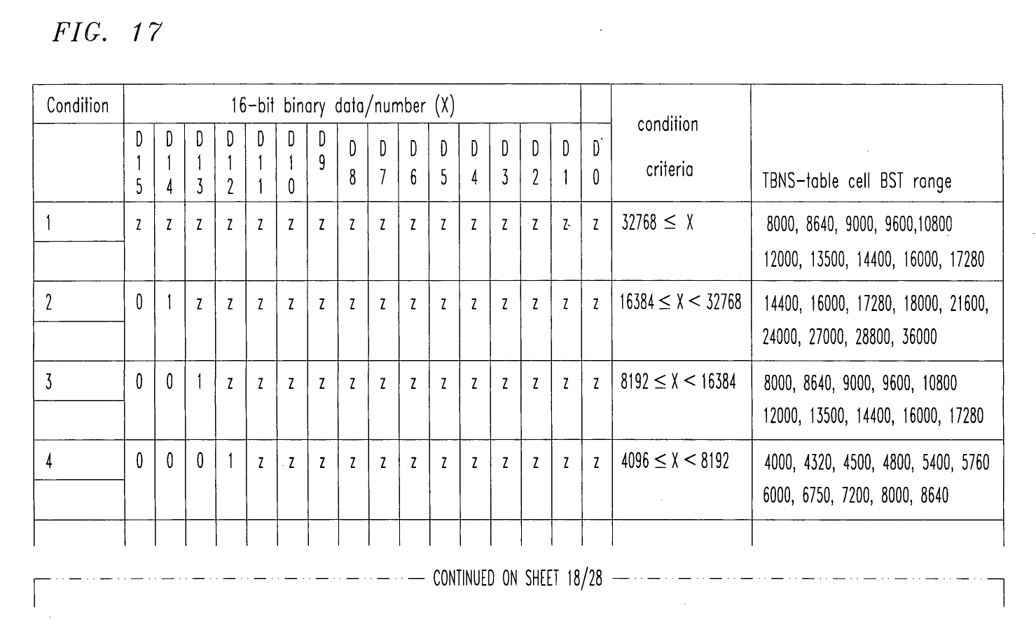

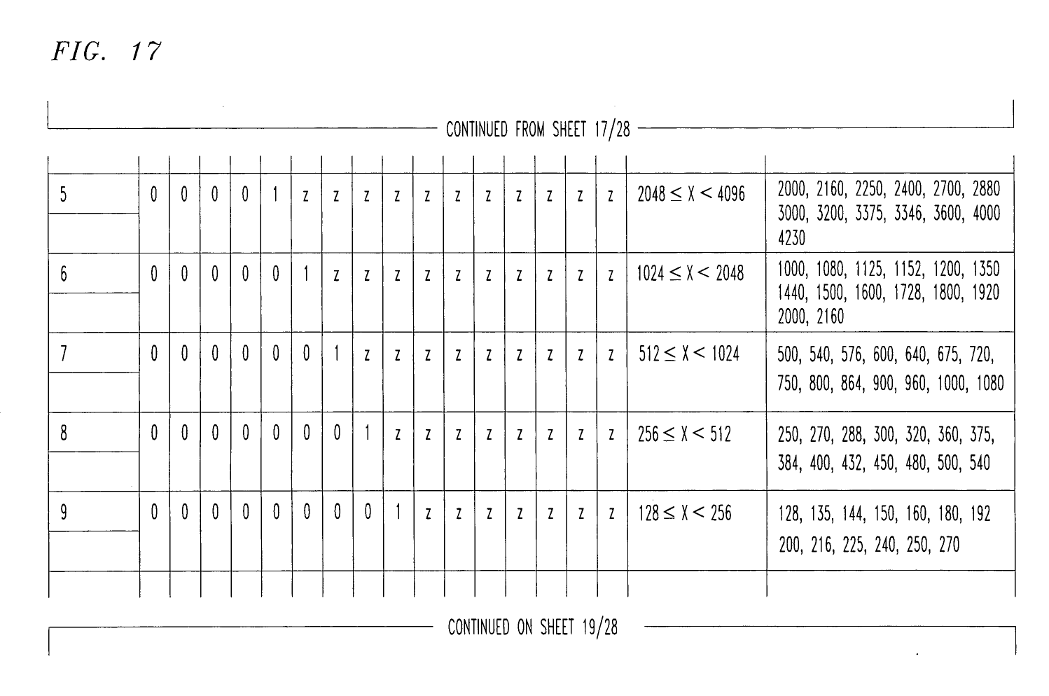

FIGS. 14(a) and 14(b) show that both the x(n) & h(k) can have a maximum of five cells to represent the number in an exemplary FIR filter.

In particular, as shown in FIGS. 14(a) and 14(b), each cell of X(k) will multiplied by five cells of h(k) and then added to generate one term. The four terms will generate four different cells of x(n), and are then added to produce the actual result.

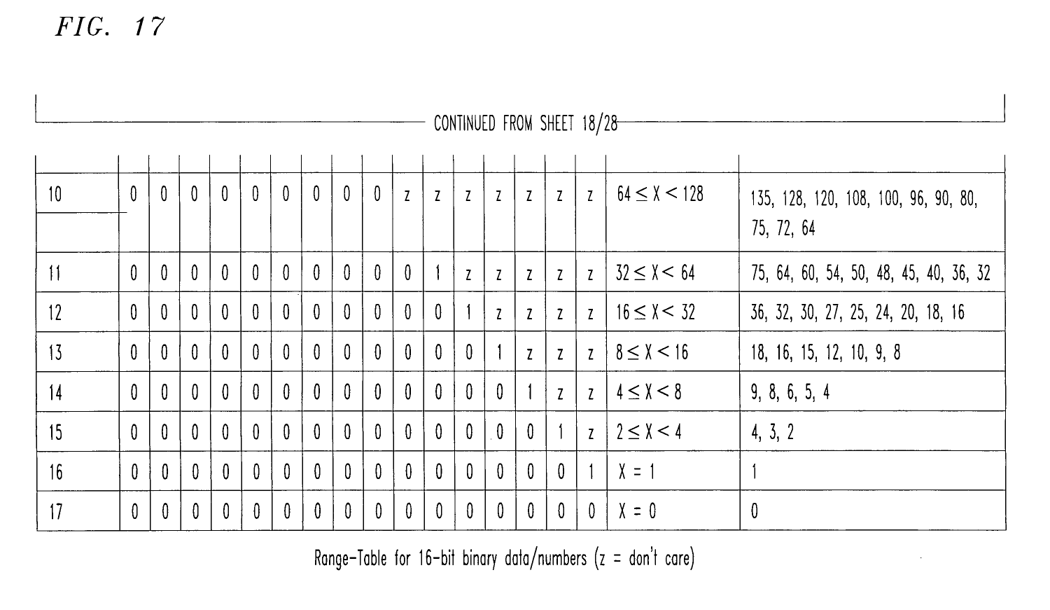

FIG. 15 shows a single cycle x(n) generation scheme forming a high precision FIR filter, in accordance with the principles of the present invention.

With the use of buffer stages SCG, the first output of a complete x(n) results after a latency of four clock pulses. After this initial output, one complete set of x(n) will output one-for-one for each subsequent clock pulse. After the initial four clock pulses, the filter generates a complete set of x(n), and all of the 25 Multipliers can compute simultaneously. The next stage Adders can compute the final result using 5 stages.

Practically all current digital processing systems utilize binary coding of data/numbers. Therefore, it becomes necessary to convert binary data/numbers into their TBNS equivalent forms to enable practical use of TBNS processing.

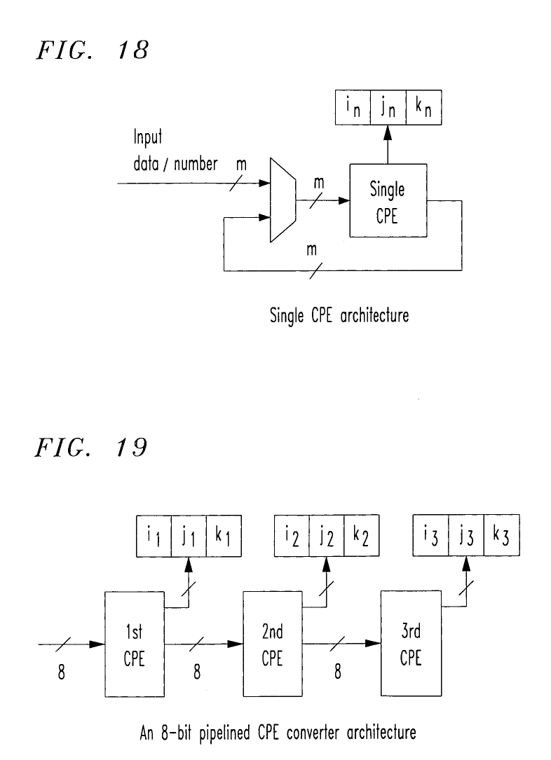

To this end, a binary search tree (BST) is a well known method of searching a finite set for a given number. When utilizing a BST to search a 3*3*3 TBNS-table for a given 8-bit data/number X, the TBNS-table cell-values are assembled as an ordered set, i.e. (1, 2, 3, 4, 5, 6, 9, 10, 12, 15, 18, 20, 25, 30, 36, 45, 50, 60, 75, 90, 100, 150, 180 and 225). FIG. 16 shows an exemplary smaller range table for 8-bit data/numbers.

In an example, using 8-bit data, the 8-bit data/number X is first compared with 20, which is adjacent the midpoint of the order. If X is greater than 20, then the 8-bit data/number X is compared with 75. If the 8-bit data/number X is less than 20, then X is compared with 6. This search process continues until X is located within the TBNS-table; which will take six comparison cycles for an 8-bit data/number.

If a binary search tree is utilized in conjunction with a range table, a novel hybrid search method results that is more efficient than is a binary search tree alone. The range table confines the BST search to the relevant sub-range of the TBNS-table cell-values. The individual sub-ranges can be easily identified from the position of the logical one (1) bits located within the target binary input data/number.

A range table can be constructed to support 16-bit, 24-bit, 32-bit, 64-bit, or any other range of data/numbers. For example, FIG. 17 shows an exemplary range table for 16-bit binary data/numbers. Such ranges are common to signal, image, multimedia, and other numerical processing applications.

Referring back to FIG. 16, if a given data/number X of 8-bits has bit D₇=1, the identity of that 8-bit data/number must be greater than or equal to 128 (binary 10000000). This indicates that the data/number X must be greater than 100, but may or may not be greater than 150 or 160 or 225. The first set of TBNS indices taken from the TBNS-table shown in FIG. 3 will be either [2,0,2] or [1,1,2] or [2,2,1] or [0,2,2]. The appropriate TBNS-table cell-value is identified and subtracted from the data/number X. The subtraction result serves as the input data/number X for use in the next iteration. Such iterations continue until a subtraction result leaves data/number X=0.

An example 8-bit binary-to-TBNS conversion on the number 215=(binary 11010111) is here described:

1^{st} iteration: Data/number X=215=(binary 11010111) has bit position D₇=1, so X is compared with the TBNS-table sub-range which holds cell-values (100, 150, 180 and 225), as denoted by the range table of FIG. 16. The 1^{st} set of TBNS [i₁,j₁,k₁] indices are determined to be [2,2,1] respectively; which are the indices linked with TBNS-table cell-value 180=(binary 10110100). Then, 180=(binary 10110100) is subtracted from X=215=(binary 11010111) with the result 35=(binary 00100011) serving as the data/number (X) for the next iteration.

2^{nd} iteration: data/number X=35=(binary 00100011) has D₇=0, D₆=0, and D₅=1, so X is compared with the TBNS table sub-range which holds cell-values (30, 36, 45 and 50), as denoted by the range table of FIG. 16. The 2^{nd} set of TBNS [i2,j₂,k₂] indices are determined to be [1,1,1] respectively, which are the indices linked with TBNS-table cell-value 30=(binary 00011110). Then, 30=(binary 00011110) is subtracted from data/number X=35=(binary 00100011) with the result 5=(binary 00000101) assigned as data/number X for the next iteration.

3^{rd} iteration: data/number X=5=(binary 00000101) has D₇=0, D₆=0, D₅=0, D₄=0, D₃=0, D₂=1, so X is compared with the TBNS table sub-range which holds cell-values (4, 5 and 6), as denoted by the range table of FIG. 16. The 3^{rd} set of TBNS [i₃,j₃,k₃] indices are determined to be [0,0,1] respectively, and which are the indices linked with TBNS-table cell-value 5=(binary 00000101). Then, 5=(binary 00000101) is subtracted from X=5=(binary 00000101), with the result zero=0=(binary 00000000) signalling the completion of the conversion process.

FIG. 18 shows exemplary architecture of an m-bit single conversion processing element (CPE) converter, in accordance with the principles of the present invention.

In particular, as shown in FIG. 18, a single conversion processing element (CPE) converter architecture can be utilized where the output of the single CPE is routed back to its input to perform the successive iterations. A single CPE architecture trades conversion speed for lower converter cost and power consumption.

FIG. 19 shows alternative exemplary architecture of an 8-bit pipelined conversion processing element (CPE) converter, in accordance with the principles of the present invention.

In particular, as shown in FIG. 19, the CPE may be configured in a pipelined architecture to exploit the temporal locality typical of signal processing data.

The converter and CPE architectures can be scaled to support any data/number word-size required. In example, an 8-bit pipelined converter requires three CPE, and a 16-bit pipelined converter requires five CPE.

CPE can be architected for maximum speed by incorporating a number of comparison units which are equal to the maximum number of TBNS table cell-value pairs that may be encountered from any sub-range of the Range Table. The number of comparison units should be rounded up to include the unpaired cell-value that will occur when the sub-range with the most number of cell-values contains an odd number of them, in which case the unpaired cell-value can be paired with a dummy partner value. A suitable dummy partner cell-value would be the next numerically sequential TBNS table cell-value beyond the limits of the relevant sub-range defined in the Range Table.

CPE architected in accordance with this invention can apply all comparison units in parallel to obtain a first-order search result which reduces the search for the correct cell-value to only two remaining possibilities. This initial search result is obtained in a single comparison time cycle, regardless of the number of the word-size of the input data/number.

In example, the maximum number of cell-value pairs contained within any sub-range of the 8-bit Range Table of FIG. 16 is two and one-half pairs. Therefore, an 8-bit CPE optimized for speed will feature three comparators.

In example, the maximum number of cell-value pairs contained within any sub-range of the 16-bit Range Table of FIG. 17 is seven pairs. Therefore, a 16-bit CPE optimized for speed will feature seven comparators.

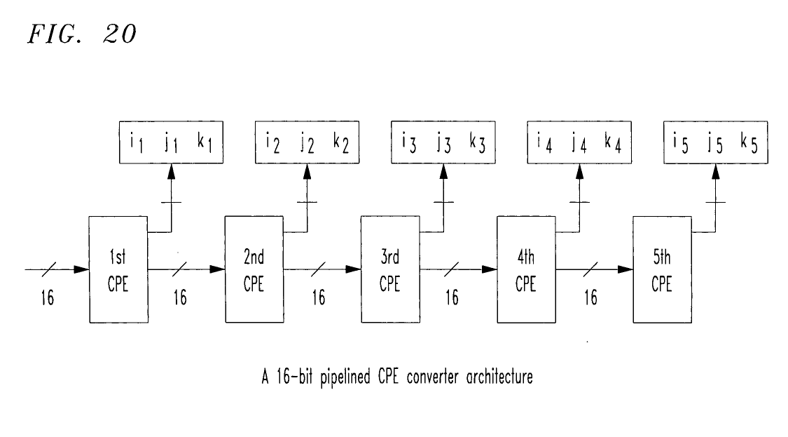

FIG. 20 shows exemplary architecture of a 16-bit pipelined conversion processing element (CPE) converter, in accordance with the principles of the present invention.

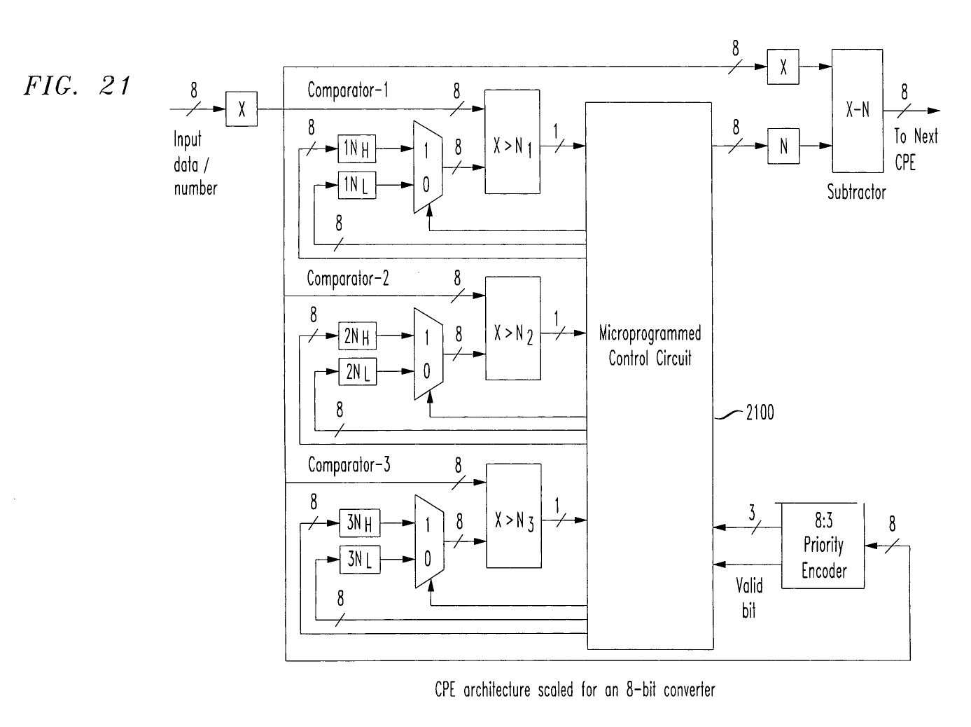

FIG. 21 shows exemplary architecture of a conversion processing element (CPE) scaled for an 8-bit converter, in accordance with the principles of the present invention.

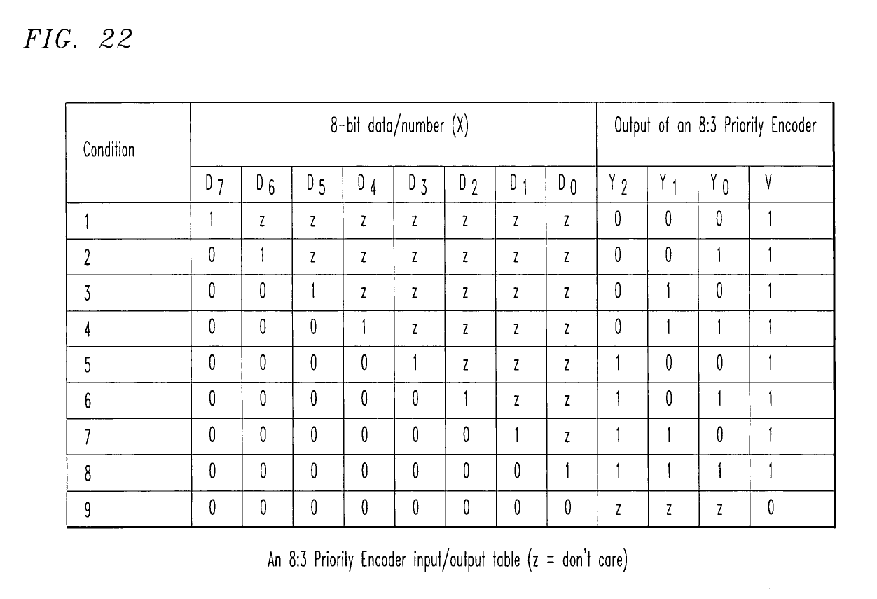

FIG. 22 shows an exemplary priority encoder input/output table, in accordance with the principles of the present invention. The priority encoder is scaled according to [m:(log2m)], where m equals the number of bits within the binary data/number to be converted.

In particular, as shown in FIG. 21, a microprogrammed control unit 2100 is used to reduce both hardware and time complexity of the conversion process. The control unit 2100 stores the TBNS-table cell-values in a suitable memory, and accesses them as signalled by the priority encoder. The TBNS table cell-values are ordered in pairs and sequenced in numerical order by sub-range. The TBNS [i,j,k] indices associated with the TBNS-table cell-values are stored in a suitable lookup table or memory. Control unit 2100 detects a condition indicated by the priority encoder, which accesses the relevant sub-range of TBNS-table cell-values for comparison with the input data/number.

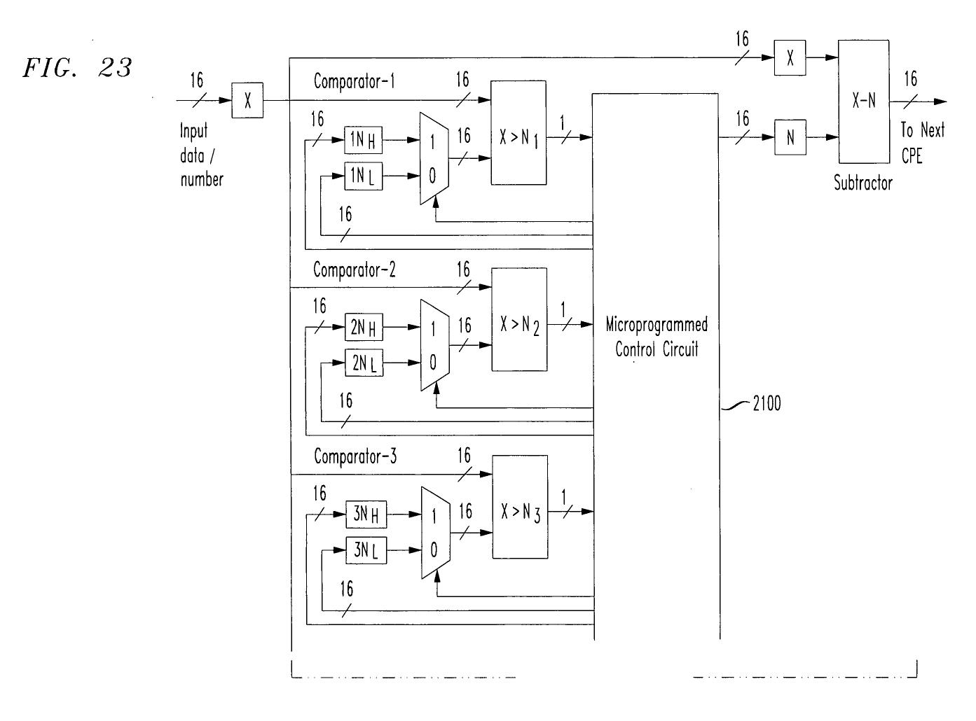

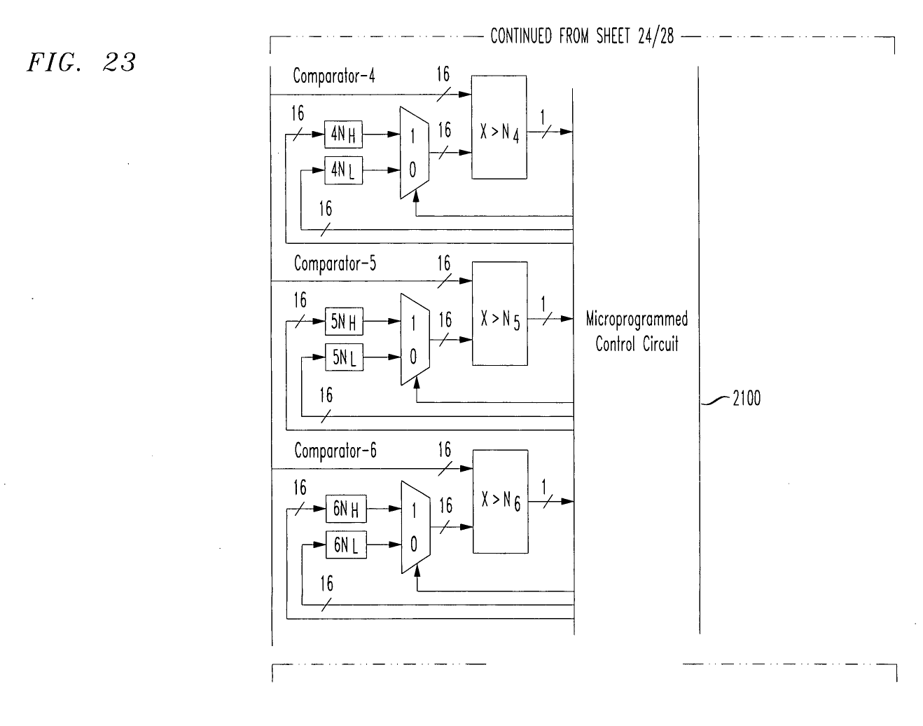

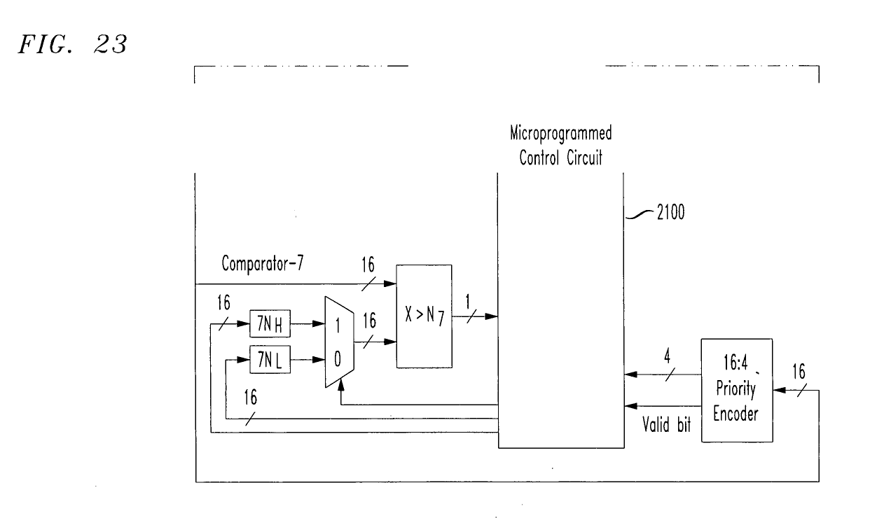

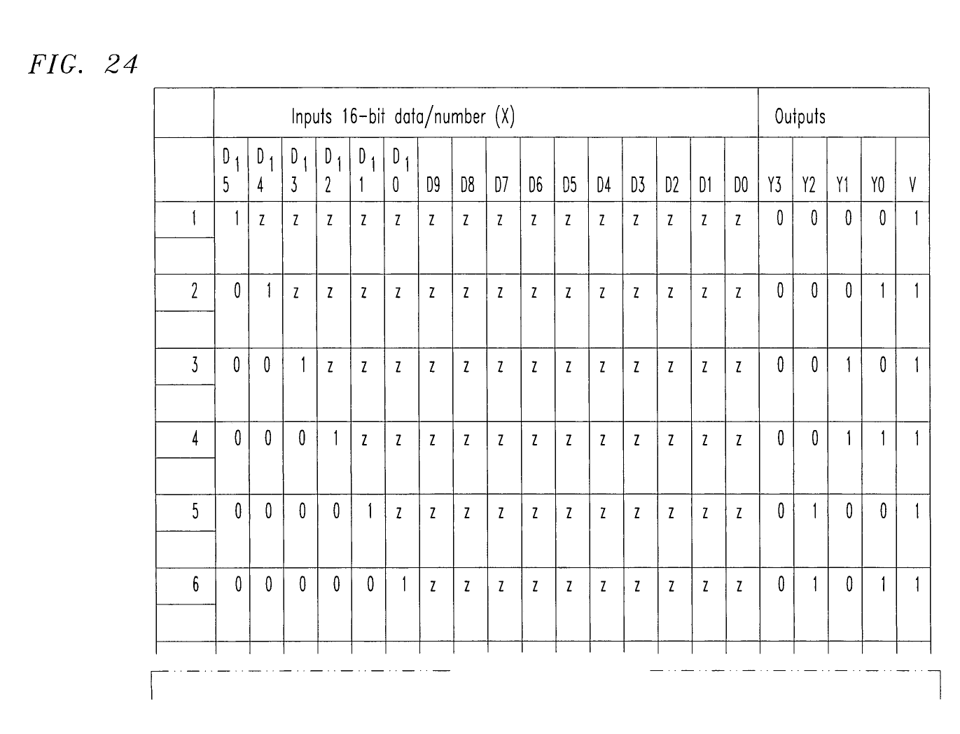

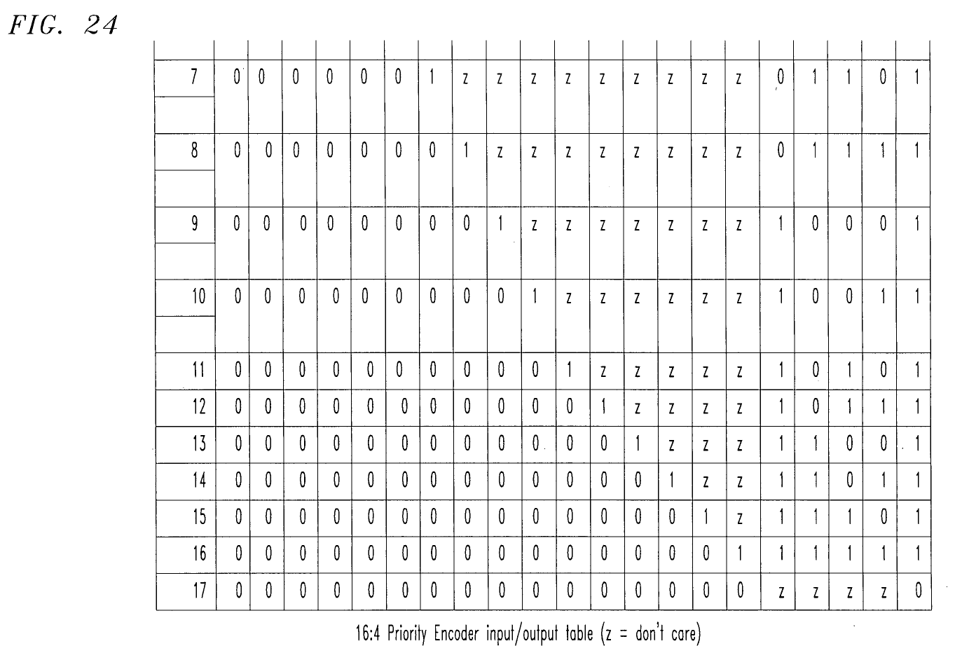

As shown in FIG. 21 and in FIG. 23, Input data/number (X) is buffered at the input to the CPE. The relevant TBNS table sub-range, as indicated by the priority encoder and defined in the Range Table, has its lowest two cell-values sent as an ordered pair to comparator-1 input buffers 1N_{H} and 1N_{L} by control unit 2100. Buffer 1N_{H} holds the higher value of the pair, while buffer 1N_{L} holds the lower value of the pair. The next two higher cell-values are sent as an ordered pair to comparator-2 input buffers 2N_{H} and 2N_{L}, and so forth, so that all cell-values of the relevant sub-range are sent as ascending ordered pairs to the comparison units. The comparison units are ranked in ascending order beginning from comparator-1. Preferably, all cell-value pairs are sent to the comparison units in parallel transfer to minimize time complexity.

In a 1^{st} comparison cycle, each comparison unit evaluates the TBNS table cell-value loaded to its own respective buffer N_{H} with the input data/number (X). Control unit 2100 identifies the lowest ranking comparison unit NOT to find X greater than the cell-value loaded to that comparison unit's particular buffer N_{H}. Such comparison unit becomes the subject comparison unit in the 2nd comparison cycle. The remaining search for the correct cell-value is automatically reduced to a choice between the cell-value which was loaded to buffer N_{L} of the subject comparison unit, and the cell-value immediately subordinate to that loaded to buffer N_{L} and which is also within the relevant sub-range.

In a 2nd comparison cycle, control unit 2100 signals the subject comparison unit to select the cell-value loaded in the subject comparison unit's buffer N_{L} for comparison with X. If this comparison finds X>N_{L} is true, then the cell-value in the subject comparison unit's buffer N_{L} is sent by control unit 2100 to input buffer N of a subtractor unit, else the cell-value immediately subordinate to the cell-value in the subject comparison unit's buffer N_{L} is sent by control unit 2100 to input buffer N of the subtractor unit. The TBNS [i,j,k] indices associated with whichever TBNS-table cell-value was sent to the subtractor unit input buffer N now become one set of such indices which comprise the TBNS representation of X.

The subtractor unit subtracts the cell-value sent to input buffer N from the input data/number X. The subtraction result is forwarded to the next CPE if in a pipelined architecture converter, or is sent back to the input if in a single CPE architecture converter. This completes a single iteration.

When a zero is encountered by a conversion processing element (CPE), it is preferably flagged by a valid bit (V) output of the priority encoder. This conversion method can be adapted to support the conversion of data/numbers of 16-bit, 24-bit, 32-bit, 64-bit, or whatever required word-size in accordance with principles of the present invention. A converter built in accordance with the principles of this invention will never require more than two comparison cycles to identify the correct table cell-value, regardless of the input data/number word-size.

In particular, as shown in FIG. 22, conversion processing element (CPE) architecture for the conversion of 8-bit data/numbers preferably features an 8:3 priority encoder with inputs D₇-D₀, and outputs Y₂, Y₁, Y₀, and V(valid bit).

In particular, as shown in FIG. 23, conversion processing element (CPE) architecture for the conversion of 16-bit data/numbers preferably features an 16:4 priority encoder with inputs D₁₅-D₀, and outputs Y₃, Y₂, Y₁, Y₀, and V(valid bit).

In example, suppose 16-bit data/number (X)=16500=(binary 0100000001110100) is encountered by the 1^{st} CPE of a pipeline architecture 16-bit converter, such as that shown in FIG. 20. The 16:4 priority encoder inputs detect that bits D₁₅₌₀ and D₁₄₌₁ so, its outputs become Y₃=0, Y₂=0, Y₁=0, Y₀=1 and V=1 which indicate that X has a value somewhere from 16384 to 32767, as defined in the exemplary 16-bit Range Table shown in FIG. 17.

As shown in FIG. 23, control unit 2100 detects the condition indicated by a 16:4 priority encoder and accesses the relevant sub-range of TBNS-table cell-values from memory, and sends them to the comparison units matched to comparison unit rank order.

The relevant TBNS table cell-value pairs in this example are:
(14400 and 16000)
(17280 and 18000)
(21600 and 24000)
(27000 and 28800)
Resulting in:

### Comparator-1 buffers 1N_{L}=14400 and 1 N_{H}=16000

### Comparator-2 buffers 2N_{L}=17280 and 2N_{H}=18000

### Comparator-3 buffers 3N_{L}=21600 and 3N_{H}=24000

### Comparator-4 buffers 4N_{L}=27000 and 4N_{H}=28800

### Comparison units 5, 6, and 7 are not relevant to this sub-range, as is indicated in the exemplary 16-bit Range Table shown in FIG. 17.

In a 1^{st} comparison cycle, comparator-1 finds X>16000 is true, while comparator-2 finds X>18000 is NOT true. As comparator-2 finds a negative result, the remaining five higher ranked comparison units, 3 through 7, must also find negative results. The lowest ranking negative result, which was found by comparator-2, reduces the correct cell-value search to the two cell-values immediately subordinate to the cell-value which is loaded in comparator-2 buffer 2^{N}H (18000). Those two immediately subordinate cell-values are 17280 and 16000.

In a 2^{nd} comparison cycle, comparator-2 finds X>2H_{L} (17280) is NOT true. This dictates that the correct table cell-value to be sent to the subtractor unit must be the cell-value immediately subordinate to 17280. That cell-value is 16000. Thus, the TBNS [i,j,k] indices associated with TBNS-table cell-value 16000 become one set of such indices forming the TBNS representation of X.

Cell-value 16000 is subtracted from the input data/number (X) and the result forwarded to the next CPE. This completes a single iteration. At least one, and at most two comparison cycles are required to complete a single iteration and derive a set of TBNS indices utilizing this hybrid Binary Search Tree/Range Table based conversion method.

A digital triple base number system (TBNS) processor built in accordance with the principles of the present invention enables resource efficient, high-speed signal or numerical processing of larger word-size data or numbers. In such applications, a TBNS processing architecture proves much more efficient as compared to either a traditional single base number system (SBNS) or even a double base number system (DBNS) processing.

While the invention has been described with reference to the exemplary embodiments thereof, those skilled in the art will be able to make various modifications to the described embodiments of the invention without departing from the true spirit and scope of the invention.

What is claimed is:

1. In a processor, a Multiplication Unit comprising:
at least three Adders, each of said at least three Adders adding an extracted pair of like powers of two numbers to be multiplied;
a lookup table; and
a barrel shifter;
a result of a first of said at least three Adders controlling a number of bits of shift of a barrel shifter; and
a result of remaining ones of said at least three Adders being input to said lookup table.

2. In a processor, a Multiplication Unit according to claim 1 wherein:
said at least three Adders are each a respective binary Adder.

3. In a processor, a Multiplication Unit according to claim 1, further comprising:
a register to hold an output of said barrel shifter.

4. In a processor, a Multiplication Unit according to claim 1, wherein:
said Multiplication Unit forms a triple-base number system Multiplication Unit.

5. In a processor, a Multiplication Unit according to claim 1, wherein:
said Multiplication Unit forms a 4-base number system Multiplication Unit.

6. In a processor, a Multiplication Unit according to claim 1, wherein:
said barrel shifter has at least 32 bits.

7. In a processor, a Multiplication Unit according to claim 1, wherein:
said lookup table comprises at least 1856 bits.

8. In a processor, a Multiplication Unit according to claim 1, wherein:
said processor is a digital signal processor.

9. A single cycle generation architecture for a high precision finite impulse response (FIR) filter, comprising:
a plurality of single cycle generators connected in series, a first one of said plurality of single cycle generators having as an input a signal sample, and each of said plurality of single cycle generators providing an output signal to a respective buffer stage of said FIR filter;
wherein each of said plurality of single cycle generators comprise a triple-base number system (TBNS) Multiplication Unit.

10. A method of multiplying multiple numbers in a processor, comprising:
extracting triple-base powers from each of said multiple numbers;
adding like triple-base powers for each of said multiple numbers into a single binary power result;
inputting results of the highest two powers into a lookup table, an output of said lookup table being input to a barrel shifter;
inputting a result of a lowest power to control a number of bits of shift of said barrel shifter, an output of said barrel shifter representing a result of said multiplication operation.

11. The method of multiplying multiple numbers in a processor according to claim 10, further comprising:
converting an initial base of each of said multiple numbers into a triple-base.

12. The method of multiplying multiple numbers in a processor according to claim 11, wherein:
said initial base of each of said multiple numbers is a single-base.

13. The method of multiplying multiple numbers in a processor according to claim 10, further comprising:
storing an output from said barrel shifter into a register.

14. The method of multiplying multiple numbers in a processor according to claim 10, wherein:
said multiple numbers comprise at least 3 numbers to be multiplied.

15. The method of multiplying multiple numbers in a processor according to claim 10, wherein:
said barrel shifter has at least 32 bits.

16. The method of multiplying multiple numbers in a processor according to claim 10, wherein:
said lookup table comprises at least 1856 bits.

17. The method of multiplying multiple numbers in a processor according to claim 10, wherein:
said processor is a digital signal processor.

18. Apparatus for multiplying multiple numbers in a processor, comprising:
means for extracting triple-base powers from each of said multiple numbers;
means for adding like triple-base powers for each of said multiple numbers into a single binary power result;
means for inputting results of the highest two powers into a lookup table, an output of said lookup table being input to a barrel shifter;
means for inputting a result of a lowest power to control a number of bits of shift of said barrel shifter, an output of said barrel shifter representing a result of said multiplication operation.

19. The apparatus for multiplying multiple numbers in a processor according to claim 18, further comprising:
means for converting an initial base of each of said multiple numbers into a triple-base.

20. The apparatus for multiplying multiple numbers in a processor according to claim 19, wherein:
said initial base of each of said multiple numbers is a single-base.

21. The apparatus for multiplying multiple numbers in a processor according to claim 18, further comprising:
means for storing an output from said barrel shifter into a register.

22. The apparatus for multiplying multiple numbers in a processor according to claim 18, wherein:
said multiple numbers comprise at least 3 numbers to be multiplied.

23. The apparatus for multiplying multiple numbers in a processor according to claim 18, wherein:
said barrel shifter has at least 32 bits.

24. The apparatus for multiplying multiple numbers in a processor according to claim 18, wherein:
said lookup table comprises at least 1856 bits.

25. The apparatus for multiplying multiple numbers in a processor according to claim 18, wherein:
said processor is a digital signal processor.

26. A method of searching a multiple-base number system table, comprising:
arranging said multiple-base number system table into a plurality of sub-ranges;
reducing a search of said multiple-base number system table to a relevant sub-range;
searching said relevant sub-range of said multiple-base number system table via a binary-search-tree method; and
reducing search time on said multiple-base number system table via parallel application of said binary-search-tree method to simultaneously evaluate values of suitable sub-ranges.

27. A conversion processing element, comprising:
a control unit;
a memory;
a priority encoder;
a subtractor unit; and
at least two comparison units;
wherein said control unit is adapted to search a multiple-base number system table using a method comprising:
arranging said multiple-base number system table into a plurality of sub-ranges,
reducing a search of said multiple-base number system table to a relevant sub-range,
searching said relevant sub-range of said multiple-base number system table via a binary-search-tree method, and
reducing search time on said multiple-base number system table via parallel application of said binary-search-tree method to simultaneously evaluate values of suitable sub-ranges.

28. A conversion processing element according to claim 27, wherein:
said conversion processing element comprises a binary to triple-base number converter apparatus.

29. A conversion processing element according to claim 27, wherein:
said conversion processing element comprises a priority encoder; and
a search range of data/numbers in said conversion processing element is reduced.

30. A conversion processing element according to claim 27, wherein:
said conversion processing element comprises a bank of comparison units.
